(19) United States
(12) Patent Application Publication
(10) Pub. No.: US 2026/0179803 A1
(43) Pub. Date: Jun. 25, 2026

(54) RADIOISOTOPE MANUFACTURING METHOD, RADIOISOTOPE MANUFACTURING SYSTEM, AND CONTROL DEVICE

(71) Applicant: SUMITOMO HEAVY INDUSTRIES, LTD., Tokyo (JP)

(72) Inventors: Mana MIYAGAWA, Yokosuka-shi (JP); Kazuya TAKI, Niihama-shi (JP); Shuhei HARA, Niihama-shi (JP)

(21) Appl. No.: 19/390,725

(22) Filed: Nov. 17, 2025

(30) Foreign Application Priority Data
Dec. 19, 2024 (JP) 2024-223730

(51) Int. Cl. G21G 1/10

(52) U.S. Cl. CPC G21G 1/10

(57) ABSTRACT

The present invention relates to a radioisotope manufacturing method of manufacturing a radioisotope by irradiating a target with a charged particle beam includes automatically manufacturing the radioisotope based on at least a beam current of the charged particle beam and an amount of the radioisotope to be manufactured. More specifically, the target is a solid or a liquid.

### CROSS-REFERENCE TO RELATED APPLICATIONS

This application claims priority to Japanese Patent Application No. 2024-223730, filed on Dec. 19, 2024, which is incorporated by reference herein in its entirety.

### BACKGROUND

### Technical Field

A certain embodiment of the present invention relates to a radioisotope manufacturing method, a radioisotope manufacturing system, and a control device.

### Description of Related Art

A radioisotope manufacturing method has been known in the related art (for example, see the related art). In a target device, accelerated particles are introduced from an accelerator such as a cyclotron to induce a nuclear reaction with an element constituting a target. As a result, a radioisotope is generated.

### SUMMARY

One or more embodiments provide a radioisotope manufacturing method of manufacturing a radioisotope by irradiating a target with a charged particle beam, the radioisotope manufacturing method including automatically manufacturing the radioisotope based on at least a beam current of the charged particle beam and an amount of the radioisotope to be manufactured.

One or more embodiments provide a radioisotope manufacturing system that manufactures a radioisotope by irradiating a target with a charged particle beam, the radioisotope manufacturing system automatically manufacturing the radioisotope based on at least a beam current of the charged particle beam and an amount of the radioisotope to be manufactured.

One or more embodiments provide a control device for controlling a radioisotope manufacturing apparatus that manufactures a radioisotope by irradiating a target with a charged particle beam, the control device controlling the radioisotope manufacturing apparatus to automatically manufacture the radioisotope based on at least a beam current of the charged particle beam and an amount of the radioisotope to be manufactured.

### BRIEF DESCRIPTION OF THE DRAWINGS

FIG. 1 illustrates a side view schematically showing a radioisotope manufacturing system, according to the present embodiment.

FIGS. 2A to 2C illustrate schematic diagrams showing a target substrate and a target container.

FIG. 3 illustrates a block diagram showing a block configuration of the radioisotope manufacturing system.

FIG. 4 illustrates a table showing an example of various values set for each nuclide.

FIG. 5 illustrates a flowchart showing an example of the content of processing of a control device.

### DETAILED DESCRIPTION

Here, at the preliminary stage before the start of irradiation in a radioisotope manufacturing system, a mode is adopted in which a user inputs the beam current and irradiation time of a charged particle beam and the charged particle beam is turned off in a case where the irradiation time has passed. In such a mode, the user needs to perform a computation for estimating the irradiation time based on the required amount of a radioisotope to be manufactured and a beam current to be set, and to input the irradiation time. However, in the mode, in a case where a beam current is attenuated due to the consumption of a filament of an ion source or the like during the irradiation, the required integrated beam current is not achieved even though the irradiation time has passed. It has been recognized that the estimated amount of the radioisotope to be manufactured cannot be obtained.

Further, a mode may also be adopted in which a user inputs a beam current and an integrated beam current and the irradiation with the charged particle beam is turned off when an actual integrated beam current reaches the integrated beam current. In the mode, the user needs to perform a computation for estimating the irradiation time based on the required amount of a radioisotope to be manufactured and a beam current to be set, and to compute and input the integrated beam current (beam current×irradiation time). In this case, the influence caused in a case where the beam current is attenuated during the irradiation is less significant than that in the mode in which the irradiation time is input. However, It has been recognized that it is burdensome for the user since the user is required to estimate the integrated beam current in the mode. In particular, It has been recognized that the computation becomes complicated since the coefficients of a computation equation may change depending on a radioactive nuclear material to be obtained.

It is desirable to provide a radioisotope manufacturing method, a radioisotope manufacturing system, and a control device that can reduce a burden on a user.

In the radioisotope manufacturing method, a radioisotope is automatically manufactured based on at least the beam current of the charged particle beam and the amount of the radioisotope to be manufactured. Accordingly, in a case where a user inputs information on the beam current and information on the amount of the radioisotope to be manufactured, the radioisotope is automatically manufactured without any further complicated computations. Therefore, a burden on the user can be reduced.

The target may be a solid target. Alternatively, the target may be a liquid target.

The radioisotope manufacturing method may further include: acquiring information on the beam current and information on the amount of the radioisotope to be manufactured through an input performed in a case where a user operates an input unit or an input performed in a case where identification information for identifying the solid target is read. Alternatively, the radioisotope manufacturing method may further include: identifying a type of the target and acquiring information on the beam current and information on the amount of the radioisotope to be manufactured through an input performed in a case where a user operates an input unit or an input performed in a case where identification information for identifying a target container is read. The user can set desired information by operating the input unit. The user can easily input the information through the reading of the identification information.

The radioisotope manufacturing method may further include: automatically calculating an integrated beam current from a start of irradiation to an end of the irradiation, based on the beam current and the amount of the radioisotope to be manufactured. In this case, a burden on the user to compute the integrated beam current can be reduced.

The radioisotope manufacturing method may further include: automatically calculating an irradiation time of the charged particle beam, based on the beam current and the amount of the radioisotope to be manufactured. In this case, a burden on the user to compute the irradiation time can be reduced.

The radioisotope manufacturing method may further include: displaying the irradiation time that is automatically calculated. In this case, the user can know the irradiation time without performing computations by himself/herself.

The radioisotope manufacturing method may further include: acquiring an input parameter related to the target and for calculating an irradiation time of the charged particle beam based on the amount of the radioisotope to be manufactured. In this case, it is possible to perform a computation taking into consideration the input parameters required for the calculation.

The radioisotope manufacturing method may further include: acquiring the input parameter through an input performed in a case where a user operates an input unit or an input performed in a case where identification information for identifying the target is read. The user can set the input parameters, which are identified by the user, by operating the input unit. The user can easily input the input parameters through the reading of the identification information.

The radioisotope manufacturing method may further include: updating a display content of the irradiation time in a case where the beam current fluctuates during the irradiation with the charged particle beam. In this case, an appropriate irradiation time can be displayed to the user in response to a fluctuation of the beam current during the irradiation.

According to the radioisotope manufacturing system and the control device, it is possible to obtain operational effects similar to those of the above-described radioisotope manufacturing method.

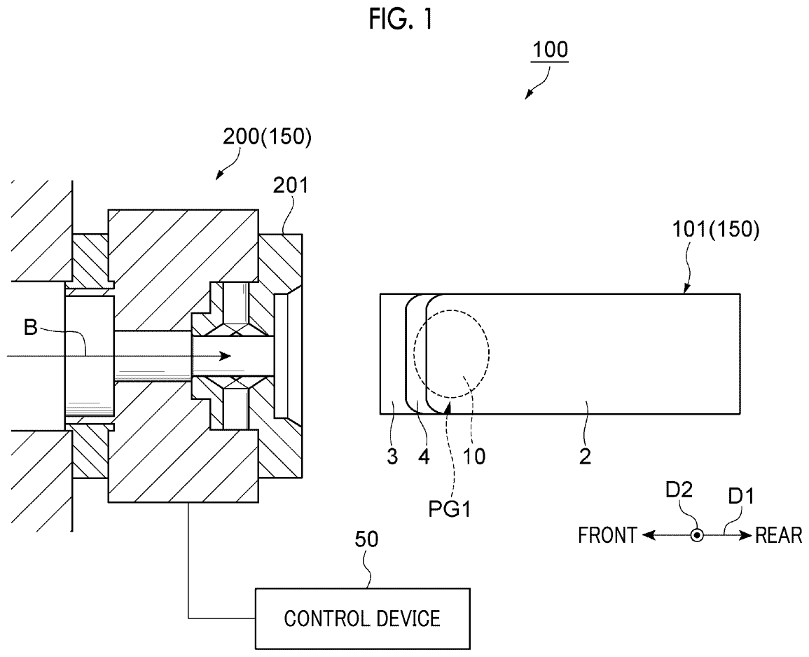

A radioisotope manufacturing system 100 according to an embodiment will be described with reference to the drawings. FIG. 1 is a side view schematically showing the radioisotope manufacturing system 100. As shown in FIG. 1, the radioisotope manufacturing system 100 includes a radioisotope manufacturing apparatus 150 and a control device 50. The radioisotope manufacturing system 100 is a system that manufactures a radioisotope by irradiating a target substrate 10 (a target, a solid target) with a charged particle beam B. The radioisotope manufacturing apparatus 150 includes a target device 101 and a manifold 201 (irradiation unit) of an accelerator 200. A direction in which the charged particle beam B travels is referred to as a front-rear direction D1. In the front-rear direction D1, a side corresponding to the accelerator 200 is defined as a “front” side and a side opposite thereto is defined as a “rear” side. A horizontal direction perpendicular to the front-rear direction D1 is referred to as a lateral direction D2.

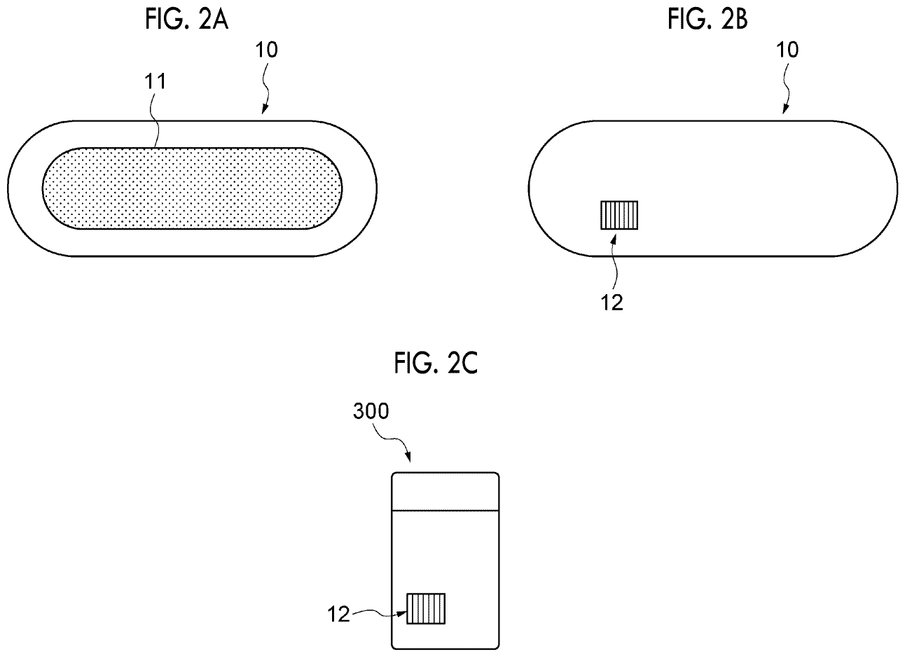

The target device 101 is a device that holds the target substrate 10. As shown in FIG. 2A, the target substrate 10 is formed in, for example, an oblong plate shape with rounded ends, and a metal layer 11 made of a target material is formed on a surface of the target substrate 10. The target substrate 10 may correspond to a plurality of types of nuclides. For example, Ni, Y, Zn, Bi, and the like are used for the metal layer of the target substrate 10. As shown in FIG. 1, in a process of manufacturing a radioisotope, the target substrate 10 is set at an installation position PG1 in the target device 101 and the target device 101 is moved from the state shown in FIG. 1 to the front side (the left side in the plane of paper) in the front-rear direction D1. Then, a front end portion of the target device 101 is inserted into the manifold 201 of the accelerator 200 and a front end surface of the target device 101 is pressed against a receiving surface of the manifold 201, so that the target device 101 is mounted on the manifold 201 of the accelerator 200. The target substrate 10 is held with respect to the irradiation direction of the charged particle beam B by the target device 101. In this state, the target substrate 10 set in the target device 101 is irradiated with the charged particle beam B from the accelerator 200. A minute amount of a radioisotope is generated by a nuclear reaction of the target material at a portion irradiated with the charged particle beam B.

The target substrate 10 may be a dissolvable metal target, and the target material can be dissolved at a dissolution port (not shown) after irradiation with the charged particle beam B. Then, after a dissolution operation, a solution is sent to a refining device (not shown) in a hot cell in a subsequent process.

The target device 101 has a columnar shape. The target device 101 includes a main body 2, a front flange 3 that is provided on the front side of the main body 2 (on the upstream side of the charged particle beam B), and an intermediate holder 4 that is provided between the main body 2 and the front flange 3. The main body 2, the intermediate holder 4, and the front flange 3 are divided in the front-rear direction D1. A joint portion between the main body 2 and the intermediate holder 4 and a joint portion between the intermediate holder 4 and the front flange 3 are present along a vertical plane obliquely intersecting the front-rear direction D1.

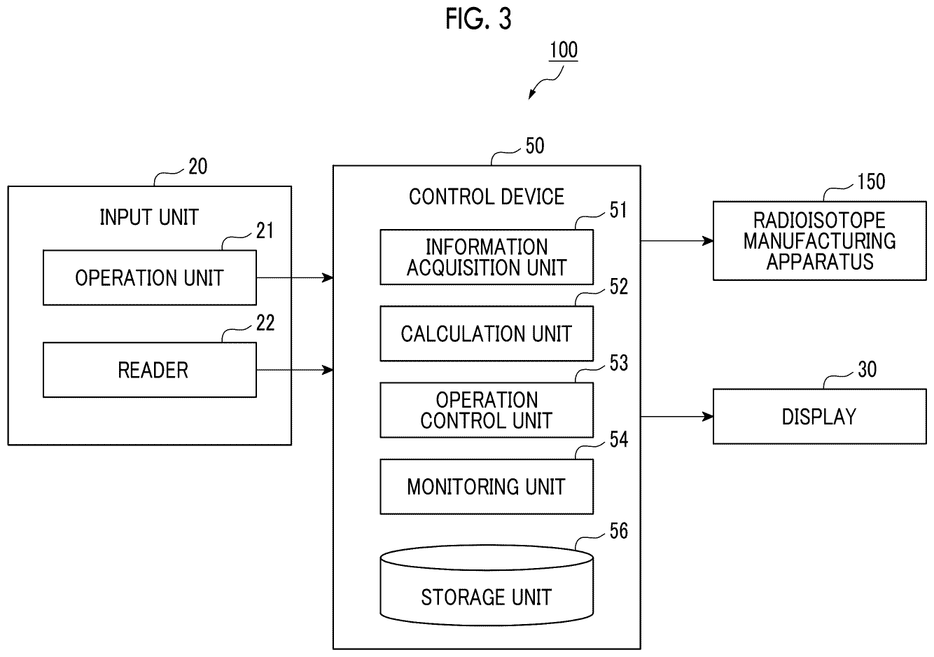

Next, a block configuration of the radioisotope manufacturing system 100 will be described with reference to FIG. 3. As shown in FIG. 3, the radioisotope manufacturing system 100 includes the radioisotope manufacturing apparatus 150 and the control device 50 that are described above, an input unit 20, and a display 30.

The input unit 20 is a section through which a user inputs various types of information to the control device 50. The input unit 20 includes an operation unit 21 and a reader 22. The operation unit 21 is a section that is operated by a user for the input of information. The operation unit 21 includes, for example, a keyboard, a mouse, switches, a touch panel, or the like. The reader 22 is a section that reads identification information for identifying the target substrate 10 to input information. The identification information for the target substrate 10 is indicated by, for example, a barcode, a QR code (registered trademark), character information, mechanical information (braille, grooves, or the like), or the like. An aspect in which the identification information is given is not particularly limited. For example, an identification information display 12 may be provided on the back surface of the target substrate 10 (see FIG. 2B). The input unit 20 transmits information, which is input by a user, to the control device 50. The reader 22 may be provided at a position to which a user presents the identification information for the target substrate 10 to cause information to be read, or at a position where that information is automatically read in a case where the target substrate 10 is set in the target device 101 (see FIG. 1).

The display 30 is a section that displays various types of information to a user. The display 30 includes, for example, a monitor, a touch panel, a mobile terminal, and the like.

The control device 50 is a device that controls the radioisotope manufacturing apparatus 150. The control device 50 is configured with, for example, a computer system. The computer system physically includes, for example, a processor (calculation circuit), a memory, a communication interface, and a data storage unit. The memory includes, for example, a read only memory (ROM) and a random access memory (RAM). The data storage unit includes, for example, a hard disk drive (HDD) or a solid state drive (SSD). The control device 50 may be configured with, for example, a microcontroller or an integrated circuit.

The control device 50 performs various types of calculation processing by executing, for example, a program stored in a memory with a CPU. As a result of this processing, the control device 50 includes functional elements shown in FIG. 3. That is, the control device 50 includes an information acquisition unit 51, a calculation unit 52, an operation control unit 53, a monitoring unit 54, and a storage unit 56. The control device 50 controls the radioisotope manufacturing apparatus 150 to automatically manufacture a radioisotope, based on at least the beam current of the charged particle beam and the amount of the radioisotope to be manufactured. Accordingly, the radioisotope manufacturing system 100 can automatically manufacture a radioisotope, based on at least the beam current of the charged particle beam and the amount of the radioisotope to be manufactured. Here, “automatically manufacture a radioisotope” means that irradiation can end without requiring a new input or operation from a user regardless of fluctuations in a beam current and the like until the irradiation ends after the user inputs necessary information to instruct the irradiation to start. For example, a case where a user is requested to input an irradiation time or an integrated beam current after an input from the user does not correspond to automatic manufacture. Alternatively, a case where a process of user's re-computation or re-input of information is interposed in a case where a beam current fluctuates does not correspond to automatic manufacturing.

The information acquisition unit 51 acquires various types of information. The information acquisition unit 51 acquires the information input through the input unit 20. Further, the information acquisition unit 51 acquires information that is stored in advance in the storage unit 56. The information acquisition unit 51 acquires at least information on the beam current of the charged particle beam and information on the amount of the radioisotope to be manufactured. The information on the beam current of the charged particle beam may be a value directly indicating a required beam current, or may be information from which a required beam current can be estimated. For example, since a required beam current is determined depending on a nuclide, the information acquisition unit 51 may acquire information on a nuclide as the information on the beam current. The information on the amount of the radioisotope to be manufactured may be a value directly indicating the amount of the radioisotope to be manufactured, or may be a method of estimating the amount of the radioisotope to be manufactured. For example, the amount of the radioisotope to be manufactured may be ranked in stages and input rank information may be acquired to estimate the amount of the radioisotope to be manufactured. The information acquisition unit 51 may acquire the information on the beam current and the information on the amount of the radioisotope to be manufactured through an input performed in a case where a user operates the operation unit 21 of the input unit 20 or an input performed in a case where the identification information for identifying the target substrate 10 is read by the reader 22. The information acquisition unit 51 acquires the value of the beam current and the value of the amount of the radioisotope to be manufactured, based on the input information.

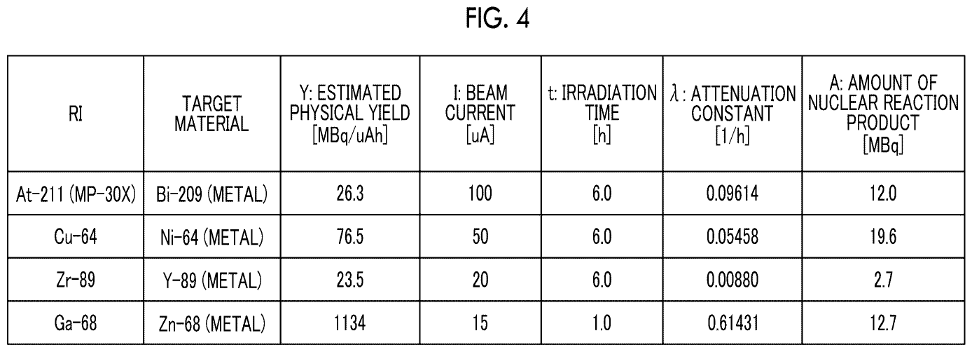

The information acquisition unit 51 may acquire input parameters related to the target substrate 10 for calculating the irradiation time of the charged particle beam, based on the amount of the radioisotope to be manufactured. The information acquisition unit 51 may acquire the input parameters through an input performed in a case where a user operates the operation unit 21 of the input unit 20 or an input performed in a case where the identification information for identifying the target substrate 10 is read by the reader 22. Examples of the input parameters include an estimated physical yield (Y) and an attenuation constant (λ) (also see FIG. 4). The input parameters may be input by the input unit 20, or may be read out from a database stored in the storage unit 56 based on the input information. For example, the information acquisition unit 51 may refer to the information on the nuclide input to the input unit 20 and the database to read out the estimated physical yield (Y) and the attenuation constant (λ), which are set in advance, from the database. All the information to be input to the input unit 20 may be input through the operation of the operation unit 21, all the information may be input through the reading of the identification information, which is performed by the reader 22, or a part of the information may be input through the operation and the other part of the information may be input through the reading of the identification information that is performed by the reader 22.

The calculation unit 52 performs various calculations in the control device 50. The calculation unit 52 may automatically calculate an integrated beam current from the start of the irradiation to the end of the irradiation, based on the beam current and the amount of the radioisotope to be manufactured. Further, the calculation unit 52 may automatically calculate the irradiation time of the charged particle beam, based on the beam current and the amount of the radioisotope to be manufactured.

The following equation (1) may be used as an example of an equation that the calculation unit 52 uses to perform a calculation. As described above, “A: amount of nuclear reaction product” is set based on the amount of the radioisotope to be manufactured which is input by a user, and “I: beam current” is set based on the beam current input by a user. “Y: estimated physical yield” and “λ: attenuation constant” are set as the input parameters. Therefore, the calculation unit 52 can calculate “t: irradiation time” by substituting these values into Equation (1). FIG. 4 is a table showing an example of a target material set for each nuclide and values of each nuclide. Among these values, “Y: estimated physical yield” and “λ: attenuation constant” are values set for a nuclide. “I: beam current” is a typical beam current used for a nuclide. “A: amount of nuclear reaction product” is a value set by a user. “t: irradiation time” is an irradiation time calculated based on these values.

$$A [ MBq ] = Y \times I \times ( 1 - exp ( - λ t ) ) / λ \qquad ( 1 )$$

A: amount of nuclear reaction product [MBq]
Y: estimated physical yield [MBq/uAh]
I: beam current [μA]
t: irradiation time [hour]
λ: Attenuation Constant [hour⁻¹]

Further, the calculation unit 52 calculates the display content to be displayed on the display 30. For example, the display 30 displays the irradiation time that is automatically calculated as a calculation result of the calculation unit 52. Furthermore, the display 30 may display setting values, such as the beam current, the amount of the radioisotope to be manufactured, and the input parameters.

The operation control unit 53 controls the operation of the radioisotope manufacturing apparatus 150. The operation control unit 53 controls the ON/OFF of the irradiation with the charged particle beam emitted from the accelerator 200, and controls the beam current and the irradiation time to be the set values. The operation control unit 53 also controls the operation of the target device 101. The monitoring unit 54 monitors an operation status of the radioisotope manufacturing apparatus 150. For example, the monitoring unit 54 monitors the beam current of the accelerator 200. For example, a fluctuation in the beam current may be caused by a variation in the value of the beam current, which is due to the discharge of an ion source, or the like. Alternatively, a fluctuation in the beam current may also be caused by attenuation due to the consumption of a filament of the ion source. The calculation unit 52 updates the display content of the irradiation time in a case where the beam current fluctuates during the irradiation with the charged particle beam.

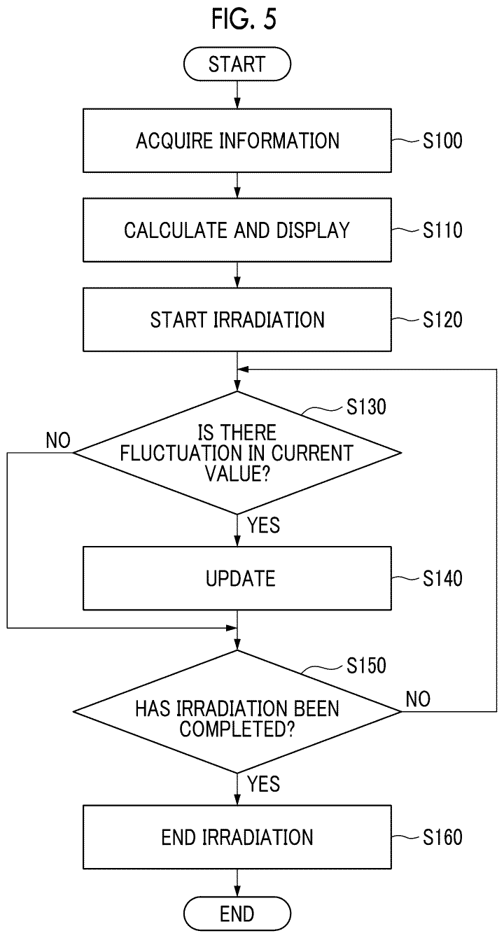

Next, an example of the content of processing performed by the control device 50 will be described with reference to FIG. 5. FIG. 5 is a flowchart showing an example of the content of the processing of the control device 50. First, as shown in FIG. 5, the information acquisition unit 51 acquires various types of information (Step S100). In this case, a user inputs necessary information through the input unit 20. Next, the calculation unit 52 computes an irradiation time based on the information acquired in S100 and causes the display 30 to display the irradiation time (Step S110). Further, the calculation unit 52 calculates an integrated beam current based on the irradiation time. Next, the operation control unit 53 controls the radioisotope manufacturing apparatus 150 to start the irradiation with a charged particle beam (Step S120). The operation control unit 53 may display an inquiry about the start to the user, and the user may perform an operation to start the irradiation or the operation control unit 53 may automatically start the irradiation.

The monitoring unit 54 monitors the beam current during the irradiation and determines whether or not there is a fluctuation in the current value of the beam current (Step S130). In a case where it is determined in Step S130 that there is a fluctuation in the current value, the calculation unit 52 recalculates the irradiation time and updates the display content on the display 30 (Step S140). In a case where it is determined in Step S130 that there is no fluctuation in the current value, the process proceeds to the next step without performing Step S140. The monitoring unit 54 determines whether or not the irradiation for a target irradiation time has been completed (Step S150). In a case where it is determined in S150 that the irradiation has not been completed, the processing is performed again from Step S130. In a case where it is determined in S150 that the irradiation has been completed, the operation control unit 53 controls the radioisotope manufacturing apparatus 150 to end the irradiation with the charged particle beam (Step S160). The display 30 displays that the irradiation has ended to notify the user of the end of the irradiation.

The operational effects of the radioisotope manufacturing method, the radioisotope manufacturing system 100, and the control device 50 described above will be described.

In the radioisotope manufacturing method, a radioisotope is automatically manufactured based on at least the beam current of the charged particle beam and the amount of the radioisotope to be manufactured. Accordingly, in a case where a user inputs information on the beam current and information on the amount of the radioisotope to be manufactured, the radioisotope is automatically manufactured without any further complicated computations. Therefore, a burden on the user can be reduced.

The information on the beam current and the information on the amount of the radioisotope to be manufactured may be acquired through an input performed in a case where the user operates the input unit 20 or an input performed in a case where the identification information for identifying the target substrate 10 is read. The user can set desired information by operating the input unit 20. The user can easily input the information through the reading of the identification information.

The integrated beam current from the start of the irradiation to the end of the irradiation may be automatically calculated based on the beam current and the amount of the radioisotope to be manufactured. In this case, a burden on the user to compute the integrated beam current can be reduced.

The irradiation time of the charged particle beam may be automatically calculated based on the beam current and the amount of the radioisotope to be manufactured.

In this case, a burden on the user to compute the irradiation time can be reduced.

The automatically calculated irradiation time may be displayed. In this case, the user can know the irradiation time without performing computations by himself/herself.

Input parameters related to the target substrate for which an irradiation time of the charged particle beam is to be calculated based on the amount of the radioisotope to be manufactured may be acquired. In this case, it is possible to perform a computation taking into consideration the input parameters required for the calculation.

The input parameters may be acquired through an input performed in a case where the user operates the input unit 20 or an input performed in a case where the identification information for identifying the target substrate 10 is read. The user can set the input parameters, which are identified by the user, by operating the input unit. The user can easily input the input parameters through the reading of the identification information.

In a case where the beam current fluctuates during the irradiation with the charged particle beam, the display content of the irradiation time may be updated. In this case, an appropriate irradiation time can be displayed to the user in response to a fluctuation of the beam current during the irradiation.

The radioisotope manufacturing system 100 according to the present embodiment is a radioisotope manufacturing system 100 that manufactures a radioisotope by irradiating a target substrate 10 with a charged particle beam and automatically manufactures the radioisotope based on at least a beam current of the charged particle beam and the amount of the radioisotope to be manufactured.

The control device 50 according to the present embodiment is a control device 50 for controlling a radioisotope manufacturing apparatus 150 that manufactures a radioisotope by irradiating a target substrate 10 with a charged particle beam, and controls the radioisotope manufacturing apparatus 150 to automatically manufacture the radioisotope based on at least a beam current of the charged particle beam and the amount of the radioisotope to be manufactured.

According to the radioisotope manufacturing system 100 and the control device 50, it is possible to obtain operational effects similar to those of the above-described radioisotope manufacturing method.

The present invention is not limited to the embodiments described above.

For example, the configuration of the radioisotope manufacturing system is not limited to the configuration shown in FIG. 1, and can be appropriately changed within the scope of the present invention. Further, the content of processing is also not limited to that shown in FIG. 5, and can be appropriately changed.

In the above-described embodiments, the target substrate which is a solid target is exemplified as a target. Alternatively, a liquid target may be adopted as the target. In a case where the liquid target is adopted, a publicly known device for a liquid target may be adopted as the radioisotope manufacturing apparatus. In a case where identification information is to be given to the liquid target, the liquid target may be stored in a target container 300 shown in FIG. 2C and the target container 300 may be provided with the identification information display 12. In this case, the radioisotope manufacturing system may identify the type of the target and acquire information on the beam current and information on the amount of the radioisotope to be manufactured through an input performed in a case where the user operates the input unit or an input performed in a case where the identification information for identifying the target container 300 is read.

It should be understood that the invention is not limited to the above-described embodiment, but may be modified into various forms on the basis of the spirit of the disclosure. Additionally, the modifications are included in the scope of the disclosure.

What is claimed is:

1. A radioisotope manufacturing method of manufacturing a radioisotope by irradiating a target with a charged particle beam, the radioisotope manufacturing method comprising:
automatically manufacturing the radioisotope based on at least a beam current of the charged particle beam and an amount of the radioisotope to be manufactured.

2. The radioisotope manufacturing method according to claim 1,
wherein the target is a solid target.

3. The radioisotope manufacturing method according to claim 1,
wherein the target is a liquid target.

4. The radioisotope manufacturing method according to claim 2, further comprising:
acquiring information on the beam current and information on the amount of the radioisotope to be manufactured through an input performed in a case where a user operates an input unit or an input performed in a case where identification information for identifying the solid target is read.

5. The radioisotope manufacturing method according to claim 3, further comprising:
identifying a type of the target and acquiring information on the beam current and information on the amount of the radioisotope to be manufactured through an input performed in a case where a user operates an input unit or an input performed in a case where identification information for identifying a target container is read.

6. The radioisotope manufacturing method according to claim 1, further comprising:
automatically calculating an integrated beam current from a start of irradiation to an end of the irradiation, based on the beam current and the amount of the radioisotope to be manufactured.

7. The radioisotope manufacturing method according to claim 1, further comprising:
automatically calculating an irradiation time of the charged particle beam, based on the beam current and the amount of the radioisotope to be manufactured.

8. The radioisotope manufacturing method according to claim 7, further comprising:
displaying the irradiation time that is automatically calculated.

9. The radioisotope manufacturing method according to claim 1, further comprising:
acquiring an input parameter related to the target and for calculating an irradiation time of the charged particle beam based on the amount of the radioisotope to be manufactured.

10. The radioisotope manufacturing method according to claim 9, further comprising:
acquiring the input parameter through an input performed in a case where a user operates an input unit or an input performed in a case where identification information for identifying the target is read.

11. The radioisotope manufacturing method according to claim 7, further comprising:
updating a display content of the irradiation time in a case where the beam current fluctuates during the irradiation with the charged particle beam.

12. A radioisotope manufacturing system that manufactures a radioisotope by irradiating a target with a charged particle beam, the radioisotope manufacturing system automatically manufacturing the radioisotope based on at least a beam current of the charged particle beam and an amount of the radioisotope to be manufactured.

13. A radioisotope manufacturing system according to claim 12, comprising:
a radioisotope manufacturing apparatus;
a control device configured to control the radioisotope manufacturing apparatus;
an input unit through which a user inputs information to the control device; and
a display configured to display information to the user.

14. The radioisotope manufacturing system according to claim 13,
wherein the radioisotope manufacturing apparatus includes a target device and a manifold of an accelerator.

15. The radioisotope manufacturing system according to claim 14,
wherein the target device has a columnar shape and includes a main body, a front flange that is provided on a front side of the main body, and an intermediate holder that is provided between the main body and the front flange.

16. The radioisotope manufacturing system according to claim 14,
wherein a front end portion of the target device is inserted into the manifold of the accelerator and a front end surface of the target device is pressed against a receiving surface of the manifold of the accelerator, so that the target device is mounted on the manifold of the accelerator.

17. The radioisotope manufacturing system according to claim 13,
wherein the input unit includes an operation unit that is a section operated by the user for input of information, and a reader that is a section configured to read identification information for identifying a target substrate to input information.

18. The radioisotope manufacturing system according to claim 13,
wherein the display is configured to display an irradiation time of the charged particle beam and display that irradiation has ended to notify the user of the end of the irradiation.

19. A control device for controlling a radioisotope manufacturing apparatus that manufactures a radioisotope by irradiating a target with a charged particle beam, the control device controlling the radioisotope manufacturing apparatus to automatically manufacture the radioisotope based on at least a beam current of the charged particle beam and an amount of the radioisotope to be manufactured.
